(19) United States
(12) Patent Application Publication
(10) Pub. No.: US 2026/0005475 A1
(43) Pub. Date: Jan. 1, 2026

(54) ELECTRICAL CONNECTOR

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: YU-MIN WANG, New Taipei (TW); JIA-HAU LIU, New Taipei (TW); NAN-HUNG LIN, New Taipei (TW); SHIH-HSUN MA, New Taipei (TW); TSU-YANG WU, New Taipei (TW); HUNG-CHENG LIAO, New Taipei (TW)

(21) Appl. No.: 19/250,755

(22) Filed: Jun. 26, 2025

(30) Foreign Application Priority Data
Jun. 28, 2024 (CN) 202410857551.3

(51) Int. Cl. H01R 13/6471; H01R 13/502

(52) U.S. Cl. CPC H01R 13/6471; H01R 13/502

(57) ABSTRACT

An electrical connector includes: an insulative housing; plural conductive terminals disposed in the insulative housing and including plural signal terminals arranged into at least one pair to transmit differential signals; and plural ground terminals comprising a first ground terminal and a second ground terminal disposed at two sides of the pair of signal terminals, the first ground terminal, the second ground terminal, and the pair of signal terminals being arranged in a row along a first direction, the ground terminals extending beyond the pair of the signal terminals along a second direction perpendicular to the first direction; and a conductive member disposed on the insulative housing, the conductive member being electrically connected to the first terminal and the second terminal but is not electrically connected to the pair of signal terminals, the conductive member having the same conductivity as the first ground terminal and the second ground terminal.

### BACKGROUND OF THE INVENTION

### Field of the Invention

The present invention generally relates to an electrical connector to transmit high-speed differential signals.

### Description of Related Arts

As an important communication bridge between multiple electronic devices, the impact of electrical connectors on the quality and speed of transmission signals is increasingly valued. U.S. Pat. No. 7,371,117 discloses a high-speed connector including a first conductive element, a second conductive element parallel to and separated from the first conductive element, a signal conductor arranged between the first conductive element and the second conductive element and not in contact with the first conductive element and the second conductive elements, and a lossy conductive member electrically connecting the first conductive element and the second conductive element but not electrically connecting the signal conductors. The lossy conductive member reduces the resonance of the grounding system in the connector and improves the high-frequency performance of the connector. However, the lossy conductive member is formed by adding conductive particles to a binder, which has a high cost and a complex manufacturing process. Therefore, an improved electrical connector design is desired.

### SUMMARY OF THE INVENTION

The main object of the present invention is to provide an improved electrical connector with better grounding performance, lower cost, and simple manufacturing process.

To achieve the above-mentioned object, an electrical connector comprises: an insulative housing; a plurality of conductive terminals disposed in the insulative housing and comprising a plurality of signal terminals being arranged into at least one pair to transmit differential signals; and a plurality of ground terminals comprising a first ground terminal disposed at one side of the pair of signal terminals and a second ground terminal disposed at the other side of the pair of signal terminals, the first ground terminal, the second ground terminal, and the pair of signal terminals being arranged in a row along a first direction, the ground terminals extending beyond the pair of the signal terminals along a second direction perpendicular to the first direction; and a conductive member disposed on the insulative housing, the conductive member being electrically connected to the first terminal and the second terminal but is not electrically connected to the pair of signal terminals, the conductive member having the same conductivity as the first ground terminal and the second ground terminal.

To achieve the above-mentioned object, an electrical connector comprises: an insulative housing; a plurality of conductors arranged in a row and comprising: a plurality of differential conductor pairs for transmitting differential signals; and a plurality of ground conductors for transmitting ground signals, each differential conductor pair disposed between two adjacent ground conductors, the ground conductor extending beyond the differential conductor pair to establish electrical connection with a mating connector before the signal conductor mates with the mating connector; and a conductive member disposed on the insulative housing, wherein the conductive element is electrically connected to all the ground conductors but is not electrically connected to any differential conductor pairs, and the conductive member is formed differently from the conductors.

Compared to prior art, the electrical connector of the present invention can provide better grounding performance, help the connector effectively improve crosstalk, and meet high-frequency characteristic requirements. In addition, the cost is low and the manufacturing process is simple.

### BRIEF DESCRIPTION OF DRAWINGS

FIG. 1 is a perspective view of an electrical connector of the present invention, together with an enlarged area;

FIG. 2 is a further exploded view of the electrical connector shown in FIG. 1;

FIG. 3 is a perspective view of a conductive member shown in FIG. 1;

FIG. 4 is a top view of the electrical connector shown in FIG. 1, together with an enlarged area;

FIG. 5 is a top view of the electrical connector shown in FIG. 3, with the terminals and the conductive member removed;

FIG. 6 is a top view of a row of conductive terminals shown in FIG. 2;

FIG. 7 is a cross-sectional view of the electrical connector shown in FIG. 1 taken along line A-A;

FIG. 8 is a cross-sectional view of the electrical connector shown in FIG. 1 taken along line B-B; and

FIG. 9 is a cross-sectional view of the electrical connector shown in 1 taken along line C-C.

### DETAILED DESCRIPTION OF DRAWINGS

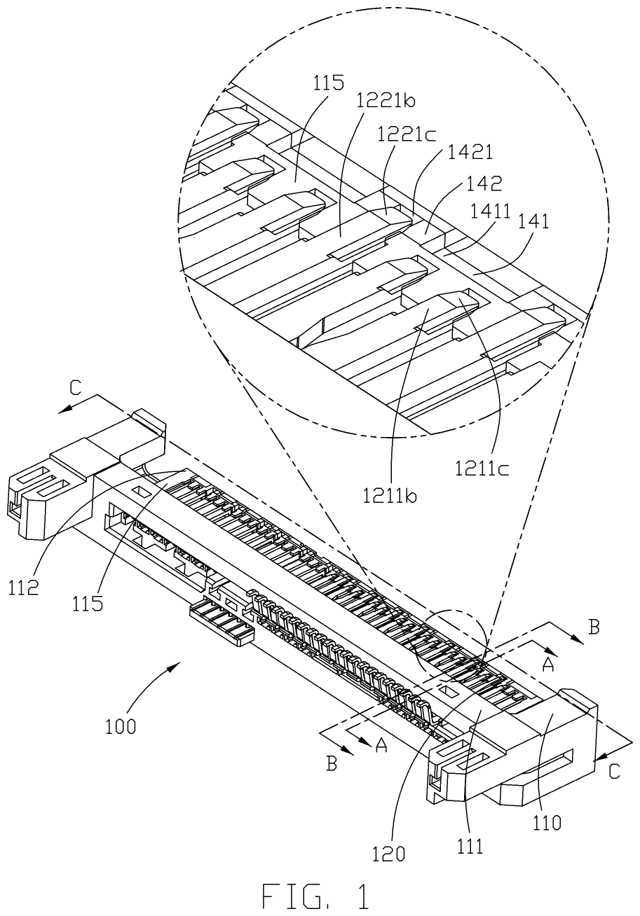

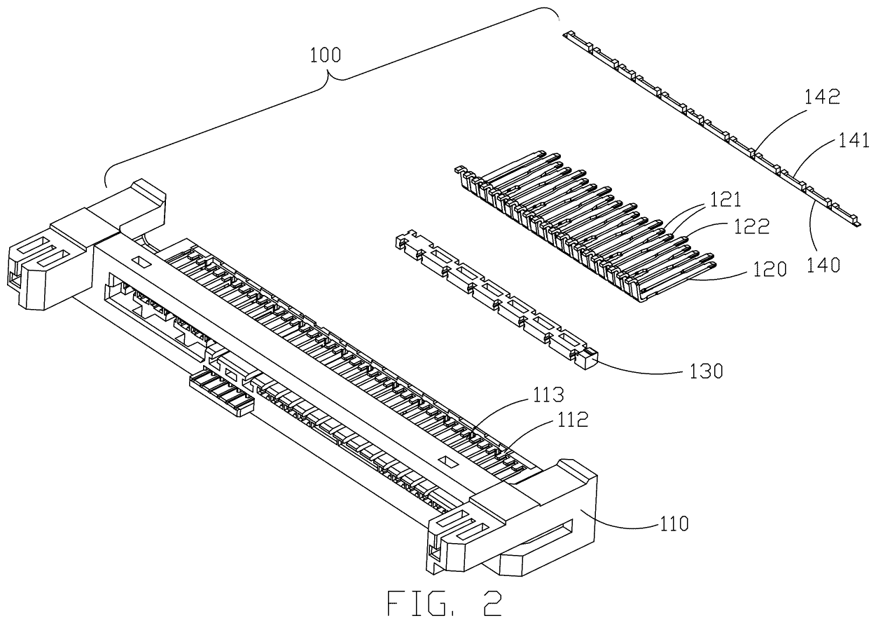

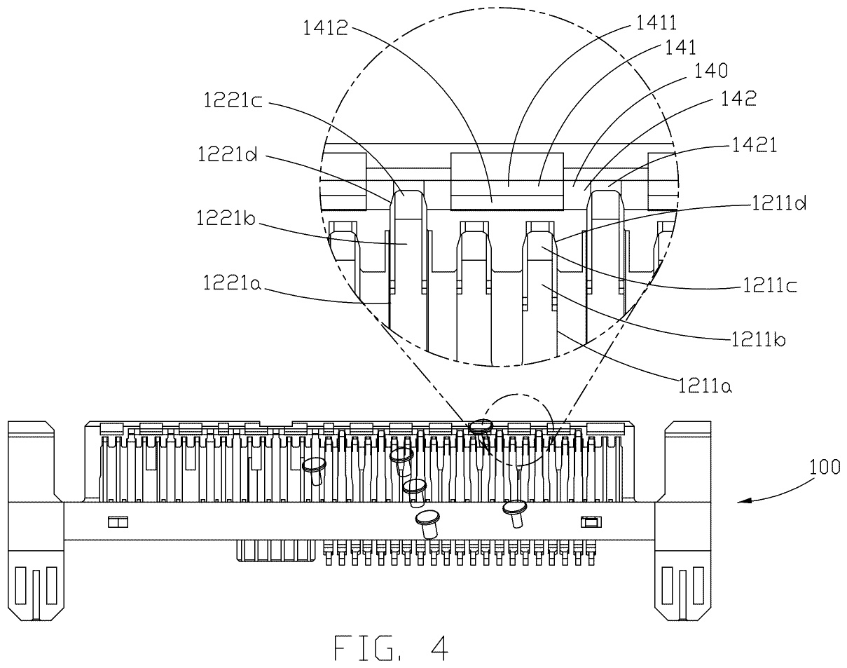

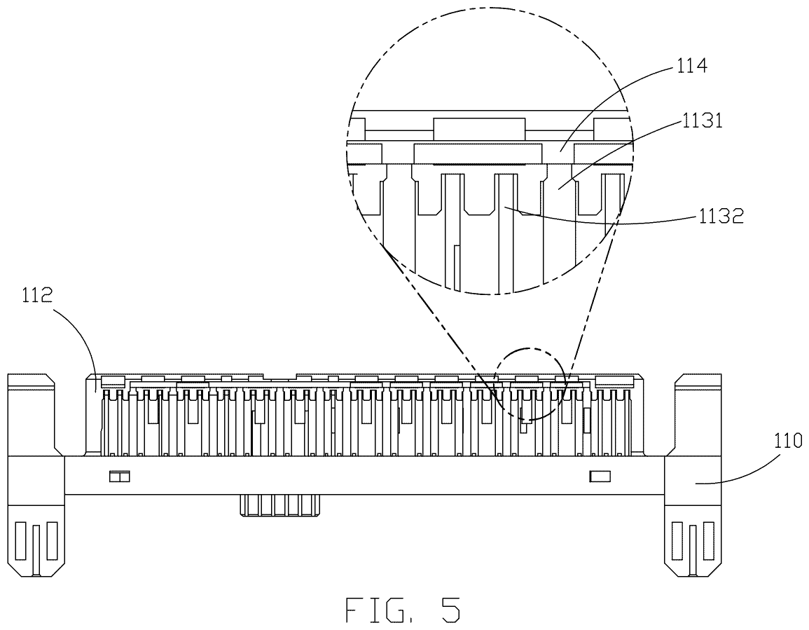

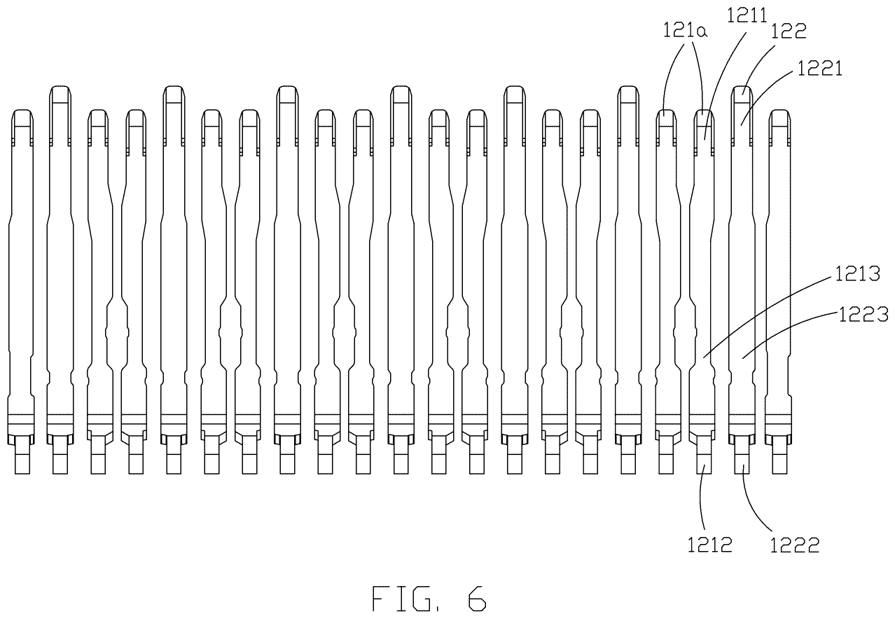

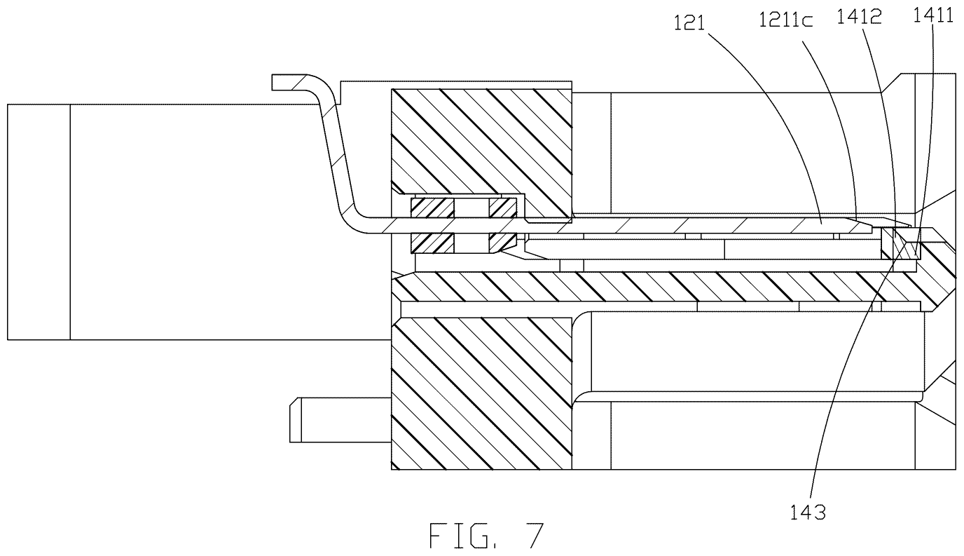

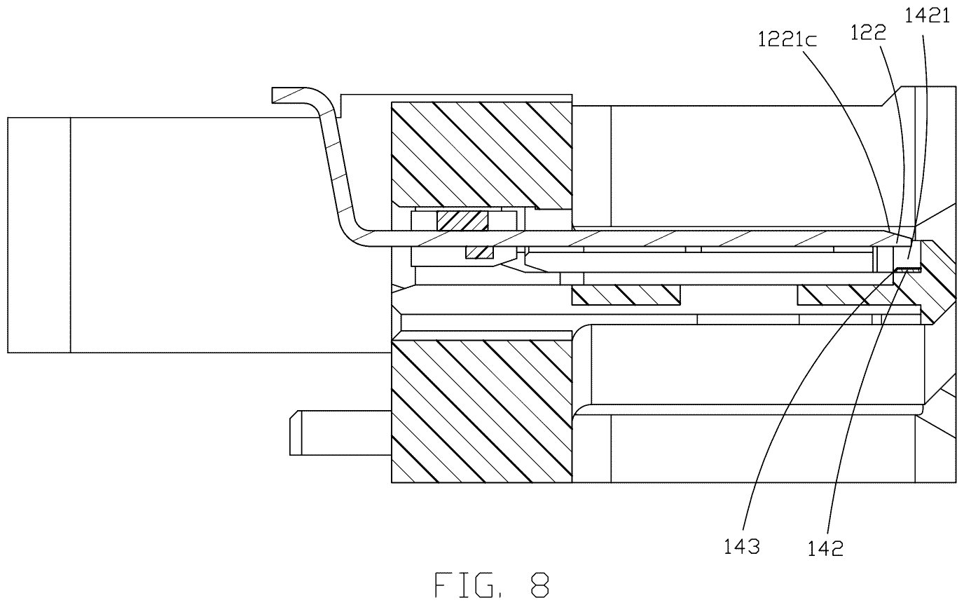

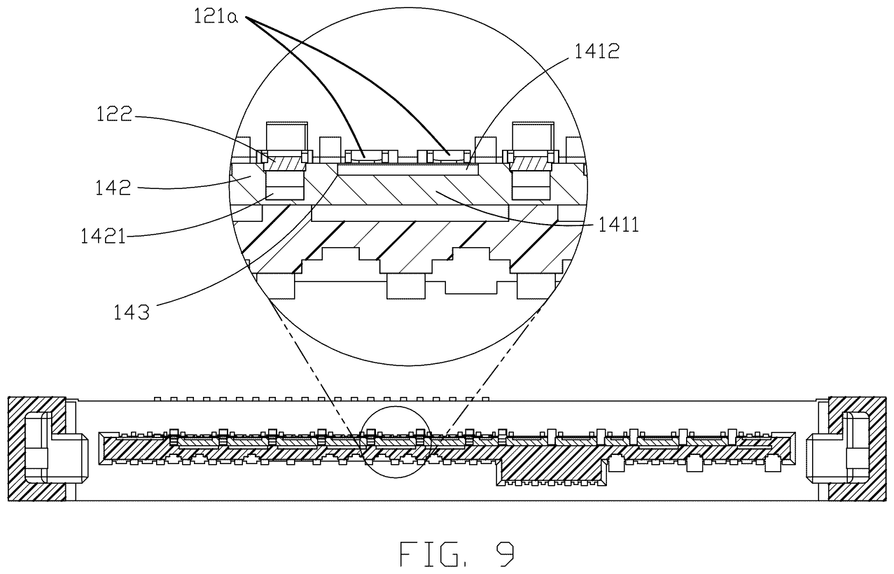

FIGS. 1-9 show an electrical connector 100 of the present invention. The electrical connector 100 includes an insulative housing 110, a plurality of conductive terminals 120 disposed on the insulative housing 110, and a fixing member 130 holding the plurality of conductive terminals 120. The plurality of conductive terminals 120 include a plurality of signal terminals 121 and a plurality of ground terminals 122. The plurality of signal terminals 121 are arranged in pairs for transmitting differential signals. Each signal terminal pair 121a is disposed between two adjacent ground terminals 122, and are arranged in a row with the ground terminals 122 along a first direction to form a GSSG arrangement. The insulative housing 110 is provided a conductive member 140 connected to the plurality of ground terminals 122 to form a common ground connection. Six pairs of differential signals can be set to form a setting of GSSGSSGSSGSSGSSGSSG, or three pairs of differential signal pairs can be set to form a setting of GSSGSSGSSG. The number of differential signal pairs and ground terminals may also be set according to specific requirements, and is not limited here. In addition to providing a plurality of differential signal pairs and ground terminals, the electrical connector may also be provided with conductive terminals having other functions, which are not limited herein.

Referring to FIGS. 1-5, specifically, the insulative housing 110 includes a base 111 and a tongue plate 112 protruding from the base along a second direction perpendicular to the first direction. The tongue plate 112 is provided with a plurality of terminal slots 113, and the plurality of terminal slots 113 include a plurality of first terminal slots 1131 for receiving the differential signal pairs 121a and a plurality of second terminal slots 1132 for receiving the ground terminals 122. The second terminal slot 1132 extends beyond the first terminal slot 1131 at the second direction. The insulative housing 110 includes a receiving groove 114 for receiving the conductive member 140, which is spaced apart from the differential signal pairs 121a along the second direction and close to the mating direction. The receiving groove 114 extends along the first direction. The second terminal groove 1132 is in communication with the receiving groove 114, and the first terminal groove 1131 is not in communication with the receiving groove 114. In this embodiment, the conductive member 140 and the insulative housing 110 are manufactured separately, and the conductive member 140 is assembled in the receiving groove 114. The conductive member 140 may be formed by metallizing the insulative material to create a metallic conductive pathway 143, utilizing processes such as laser processing, electroplating on plastic, coating with conductive adhesives or conductive materials (coating methods including but not limited to printing, spraying, adhesive application, dispensing, laminating, bonding, laser patterning, exposure and development). For example, the conductive pathway 143 can be formed through a plastic metallization process, wherein copper or gold layer are deposited by methods such as sputtering, electroless plating, or electroplating. Other metals may also be deposited as needed. As a alternative, the conductive pathway 143 may be formed using LDS (Laser Direct Structuring) technology on the plastic containing metallic particles.

In other embodiment, the conductive member 140 is directly integrally formed on the insulative housing 110, and its material is plastic with metal particles that can be used for LDS technology. The conductive pathway 143 of the conductive member 140 is directly formed on the insulative housing 110 by LDS technology, and is then mechanically and electrically connected to all the ground terminals 122. The ground terminal 122 has the same conductivity as the conductive member 140. Of course, the term “same” here does not mean absolutely the same in a narrow sense, but that the two are in the same or similar conductivity range.

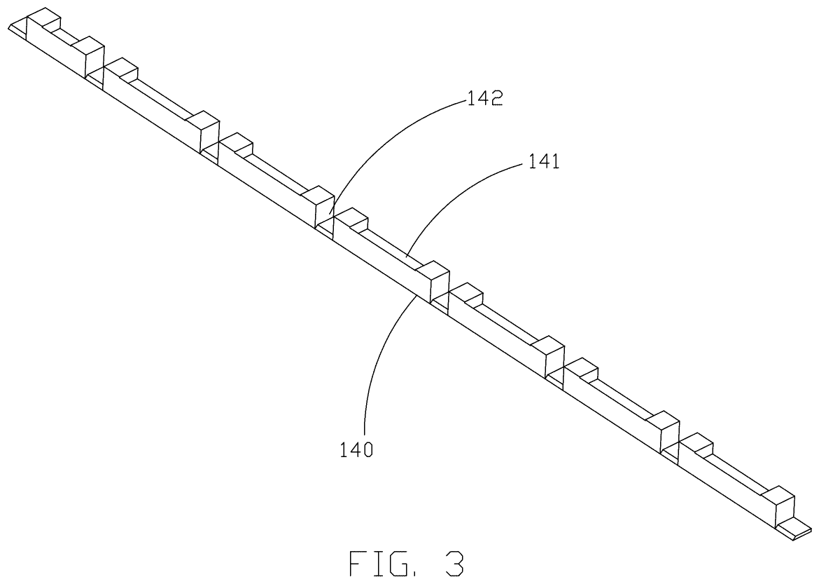

Referring to FIGS. 3-9, the conductive member 140 includes a first portion 141 corresponding to the differential signal pair 121a and a second portion 142 corresponding to ground terminal 122. The second portion 142 has a larger dimension in a third direction perpendicular to the first direction and the second direction than the first portion 141, that is, the height of the second portion 142 is greater than that of the first portion 141. The first portion 141 includes a platform portion 1411 away from the signal terminal 121 and an inclined portion 1412 disposed between the platform portion 1411 and the signal terminal 121. The dimension of the inclined portion 1412 in the third direction is greater than the dimension of the platform portion 1411 in the same direction, and the dimension of the inclined portion 1412 in the third direction gradually increases in a direction opposite to the second direction. The inclined portion 1412 extends obliquely upward from the platform portion 1411 and toward the signal terminal 121. The second portion 142 is provided with a notch 1421 opening upwards at a position corresponding to the ground terminal 122. The notch 1421 is in a square shape, and the shape of the notch is not limited. The second terminal slot 1132 extends along the second direction toward the notch 1421 and communicates with the notch 1421. The depth of the notch 1421 is greater than the thickness of the platform portion 1411.

The plurality of differential signal pairs 121a and the ground terminals 122 are integrally punched and then integrally inserted into the insulative housing 110 and accommodated in the corresponding first terminal slots 1131 and second terminal slots 1132. The length of the ground terminal 122 is greater than that of the signal terminal 121. The ground terminals 122 extend beyond the signal terminal pairs 121a along the second direction to interfere with the corresponding notch 1421 of the conductive member 140 to achieve electrical connection and conduction pathway. The ground terminals 122 extend beyond the differential signal pairs 121a so as to establish an electrical connection with the mating connector before the differential signal pairs 121a when mating with the mating connector. Furthermore, the conductive member 140 is spaced apart from the differential signal pairs 121a by a distance, and the conductive member 140 is connected to the ground terminals 122 but is not connected to the differential signal pairs 121a. Such a design enables the front ends of the plurality of ground terminals 122 to establish mechanical and electrical connections with the conductive member 140 to form a conducting pathway, thereby effectively improving crosstalk.

Referring to FIGS. 1-6, the insulative housing 110 includes a mating surface disposed on the tongue plate 112. Each signal terminal 121 include a contact portion 1211 connected to the mating connector, a tail portion 1212 connected to the mating circuit board, and a main body portion 1213 connecting the contact portion 1211 and the tail portion 1212. Each ground terminal 122 include a contact portion 1221, a tail portion 1222 connected to the mating circuit board, and a main body portion 1223 connecting the contact portion 1221 and the tail portion 1222. The contact portions 1211, 1221 protrude upward from the mating surface 115 in the third direction, and the conductive member 140 is flush with or lower than the mating surface 115 in the third direction. In this embodiment 140, the first portion 141 of the conductive member 140 is lower than the mating surface 115, and the second portion 142 of the conductive member 140 is flush with the mating surface 115. The contact portions 1211, 1221 extend upward beyond the second portion 142 of the conductive member 140 in the third direction.

Each contact portion 1211 includes a fixing area 1211a close to the terminal slot 113 and interferingly fitting with the terminal slot 113, and a matching area 1211b arranged at the front end of the terminal and having a width smaller than that of the fixing area 1211a in the first direction and which will first contact and pass with the mating terminal. Each contact portion 1221 includes a fixing area 1221a close to the terminal slot 113 and interferingly fitting with the terminal slot 113, and a matching area 1221b arranged at the front end of the terminal and having a width smaller than that of the fixing area 1221a in the first direction and which will first contact and pass with the mating terminal. The matching area 1211b is provided with an inclined guide end 1211c, and the matching area 1221b is provided with an inclined guide end 1221c. The guiding ends 1211c, 1221c extend toward the mating direction and their thickness gradually decreases. When the electrical connector is connected with the mating connector, the arrangement of the guiding ends 1211c, 1221c facilitates contact with the mating terminal. The ground terminal 122 is further provided with two inwardly inclined side edges 1221d, and the inclined side edges 1221d are interfered and fitted with the notch 1421 to form mechanical and electrical connection. The signal terminal 121 is also further provided with two inwardly inclined side edges 1211d for interference fit with the first terminal slot 1131.

In other embodiment, the electrical connector may include a circuit board, the insulative housing may be a circuit board substrate, the signal terminals and ground terminals may be conductive sheets formed on the substrate by etching technology. The conductive member may be metallized by laser processing, or plastic electroplating technology, or LDS technology, or coating with conductive adhesives or conductive materials to form a conductive pathway on the circuit board substrate. The conductive sheet for grounding extend toward the mating direction and beyond the conductive sheet for transmitting the differential signal to connect with the conductive member to form a conducting pathway. Of course, the electrical connector may also be any other suitable connector, and when these connectors transmit signals, the technical solution of the present invention may be adopted.

The ground terminal of the electrical connector of the present invention extends forward and beyond the signal terminal and then interferes with the conductive member formed by laser processing, or plastic electroplating technology, or LDS technology, or coating with conductive adhesives or conductive materials to from a conductive pathway. In this way, better grounding performance can be provided, helping the connector to effectively improve crosstalk by about 10% and meet high-frequency characteristic requirements. And can be used in PCIe6 and later generations, as well as other high-speed connectors. In addition, it has low cost and simple manufacturing process.

1. An electrical connector comprising:
an insulative housing;
a plurality of conductive terminals disposed in the insulative housing and comprising
a plurality of signal terminals being arranged into at least one pair to transmit differential signals; and
a plurality of ground terminals comprising a first ground terminal disposed at one side of the pair of signal terminals and a second ground terminal disposed at the other side of the pair of signal terminals, the first ground terminal, the second ground terminal, and the pair of signal terminals being arranged in a row along a first direction, the ground terminals extending beyond the pair of the signal terminals along a second direction perpendicular to the first direction; and
a conductive member disposed on the insulative housing, the conductive member being electrically connected to the first terminal and the second terminal but is not electrically connected to the pair of signal terminals, the conductive member having the same conductivity as the first ground terminal and the second ground terminal.

2. The electrical connector as claimed in claim 1, wherein the conductive member is spaced a distance from the pair of signal terminals in the second direction, the conductive member comprises a first portion corresponding to the pair signal terminals and a second portion corresponding to the first ground terminal and the second ground terminal, the dimension of the second portion in a third direction perpendicular to the first direction and the second direction is greater than the dimension of the first portion in the third direction.

3. The electrical connector as claimed in claim 2, wherein the second portion of the conductive member is provided with a notch, and the first grounding terminal and the second grounding terminal are interference-fitted with the corresponding notch to achieve the electrical connection.

4. The electrical connector as claimed in claim 3, wherein the insulative housing comprises a base and a tongue plate protruding from the base along the second direction, the tongue plate is provided with a plurality of terminal slots, and the conductive terminals are integrally punched and inserted into the insulative housing and accommodated in the corresponding terminal slots.

5. The electrical connector as claimed in claim 3, wherein the first portion of the conductive member includes a platform portion away from the signal terminal and an inclined portion disposed between the platform portion and the signal terminal, the dimension of the inclined portion in the third direction is greater than the dimension of the platform portion in the same direction, and the dimension of the inclined portion in the third direction gradually increases in a direction opposite to the second direction.

6. The electrical connector as claimed in claim 1, wherein the insulative housing is provided with a receiving groove for receiving the conductive member at a distance from the pair of signal terminals along the second direction, and the receiving groove extends along the first direction.

7. The electrical connector as claimed in claim 1, wherein the conductive member is formed by laser or plastic electroplating or laser direct structuring technology or conductive material coating metallization.

8. The electrical connector as claimed in claim 1, wherein the insulating housing comprises a mating surface, the conductive member comprises a contact portion, a tail portion, and a main body portion connecting the contact portion and the tail portion, the contact portion protrudes from the mating surface along the third direction, and the conductive member is flush with or lower than the mating surface in the third direction.

9. The electrical connector as claimed in claim 8, wherein the contact portion comprises a fixing area disposed near the insulative housing and interfering with the insulating housing, and a matching area smaller than the fixing area in a first direction and used to match with the mating connector, the matching area is provided with a guide end which is smaller in size in the third direction and is arranged obliquely.

10. An electrical connector comprising:
an insulative housing;
a plurality of conductors arranged in a row and comprising:
a plurality of differential conductor pairs for transmitting differential signals; and
a plurality of ground conductors for transmitting ground signals, each differential conductor pair disposed between two adjacent ground conductors, the ground conductor extending beyond the differential conductor pair to establish electrical connection with a mating connector before the signal conductor mates with the mating connector; and
a conductive member disposed on the insulative housing, wherein the conductive element is electrically connected to all the ground conductors but is not electrically connected to any differential conductor pairs, and the conductive member is formed differently from the conductors.

11. The electrical connector as claimed in claim 10, wherein the conductor is formed by stamping or etching technology, the conductive member is metallized by laser processing, or electroplating on plastics, or Laser Direct Structuring technology, or coating with conductive materials.
